(19) United States
(12) Patent Application Publication
(10) Pub. No.: US 2008/0126380 A1
(43) Pub. Date: May 29, 2008

(54) System and method for an international shipping experience map display

(75) Inventor: Tabbatha Christie Lawe, Chapel Hill, NC (US)

Correspondence Address: ALUN L. PALMER, PATENT AGENT, 4300 PINEY CHURCH ROAD, WALDORF, MD, 20602, US

(73) Assignee: MyStoreCredit.com

(21) Appl. No.: 11/434,512

(22) Filed: May 16, 2006

Related U.S. Application Data
(60) Provisional application No. 60/681,404, filed on May 16, 2005.

(51) Int. Cl. G06F 17/30; G06Q 30/00; G06F 15/16

(52) U.S. Cl. 707/102; 709/206; 705/26; 705/1; 705/10; 707/E17.018; 707/E17.005

(57) ABSTRACT

Creating and displaying an international shipping map showing destinations where a seller from a market venue has previously shipped items. The seller registers and identifies self-verified prior shipment counts to geographic areas and/or uploads a file of historical transaction information. A map is created by overlaying the cumulative count or symbol representing prior shipments on a specific pixel coordinate corresponding to the location of an appropriate geographic shipping area. The seller is next sent HTML text for the display of the seller's unique map image. The cumulative count of shipments made to a geographic area is continually incremented in response to subsequent transactions. The map image is presented by the system in response to an HTML call from the HTML text placed by the seller on an item selling web page at a market venue or placed by the seller in an HTML enabled email sent to the buyer.

### BACKGROUND OF THE INVENTION

1. Field of the Invention

This invention relates generally to systems and methods for merchandising experience in shipping items to international buyers of a domestic seller by displaying a map showing prior shipments of the seller into selected international geographic areas. This invention is particularly well suited for auctions or fixed price purchases executed at a market venue web site over networks including the Internet.

2. Description of the Background

Online transactions, like those generally conducted at eBay, Overstock, Amazon and other such market venues, occur only after a seller can establish a measure of trust with a potential buyer. Buyers will not conduct transactions if they do not trust the unseen seller. This dynamic was emphasized by eBay's CEO Meg Whitman in an article for PC World magazine in 2001, where she was quoted as saying: “Trust and safety are at the core of eBay.” Systems that improve buyer trust are critical to online venues' success and to the success of individual sellers on these venues or sellers selling from their own e-commerce sites.

Market venues like Overstock, eBay, Amazon.com and even Yahoo provide a forum for buyers and sellers to conduct transactions. To help facilitate these transactions, multiple signals of trust are exhibited on the market venue's web selling pages. Examples of these trust signals include colored stars indicating seller levels such as “power seller”, “gold power seller” and the like. Furthermore, market venues provide a mechanism for buyers and seller to leave each other feedback. Feedback is usually positive, negative or neutral. Often, a market venue will allow for prominent display of the counts of total feedback scores and will show positive feedback scores as an important signal of trust for future buyers.

Academic papers, including “Trust Among Strangers in Internet Transactions: Empirical Analysis of eBay's Reputation System”, by Paul Resnick and Richard Zeckhauser, have analyzed the importance of trust in online retail transactions and specifically the importance of signals of trust on eBay. Their paper examines the eBay feedback system and reviews its major drawbacks. The paper makes the point that: “Customer-scored reputation systems to date rely overwhelmingly on voluntarily provided information. This creates strong incentives to free ride, and quite possibly to Pollyanna (disproportionately positive) feedback.” The paper makes clear that the eBay feedback system is a critical element to eBay's success but is not without its drawbacks.

Additionally, various forms of certification marks have been developed by non-profit and for-profit entities to relay a measure of trust on market venue sites or e-commerce sites. These organizations, such as: BBBOnline, TRUSTe, WebAssured, SquareTrade, PayPal, CPAwebTrust and ReliableMerchants, etc; all provide some level of certification that indicates a code of business standards or practices which sellers use to advertise or promote trust in the seller. Once certified, the seller is given permission to display a certification image on the seller's item listing web page. Generally, these certification programs provide a minimal level of trust as most have little, if any, independent verification.

Pending patent application 11/378,432 for a “System and Method for a Repeat Customer Transaction Counter” also works to relay trust. Repeat purchases signal that a buyer trusts the seller enough to spend more of their own money and time with the seller. A visible counter of repeat transactions provides assurances to the buyer of the seller's credibility prior to a purchase.

Cross border sales, also known as international sales, on a market venue pose a unique challenge for building trust between a buyer and a seller. While positive and negative feedback and a repeat counter provide novel and innovative trust signals to most buyers, international or foreign buyers also have additional unique trust requirements. Specifically, foreign buyers seek a measure of trust or assurance that the seller has the experience of shipping internationally and ideally to the buyer's location. Buyers are better off knowing about this experience before purchasing. Because international buyers are often hindered by distance and language, and because sales on market venues often have limited time periods such as seven day auctions, the signal a buyer seeks from a seller must be easily understood and readily available on the selling screen at the time of purchase and bid.

International sales are favored by both sellers and the market venue. The internet provides a world-wide audience of buyers. Sellers maximize prices on market venues by providing items for sale to encouraging all buyers to bid or buy. Moreover, international buyers often pay higher prices for items because of the relative scarcity of the item they are seeking in their home country. For instance, a UK citizen living in China is unlikely to find British food products or British toys in their local Chinese stores. Thus, if the buyer wants the item, the buyer often turns to Internet market venues to purchase the item. In those situations, if the buyer understands that the seller has shipped items to China in prior transactions, the buyer will be more likely to purchase from the seller than if the seller provides no signal to the buyer of such experience. If a buyer chooses to pass over a seller who does not seem to have the experience of properly shipping and selling to prior buyers in their country or area, the seller loses the sale or the chance to increase the bidding by engaging the international buyer.

### OBJECTS AND ADVANTAGES

Accordingly, several objects and advantages of my invention are providing any number, or type, of market venue sellers with a simple, readily understandable system to display a geographic map on the seller's item selling page which will clearly show the seller's experience in shipping and selling items to prior buyers in a particular geography represented on the map display image. The display of the created international shipping experience map signals the depth of experience in prior sales and shipping.

The invention operates on the premise that capturing international shipping transactions and overlaying symbols or numbers of the seller's cumulative experience of shipping items to prior buyers in foreign countries on the map will help increase the trust level for pending international buyers and will facilitate higher bidding and ultimately completion of future transactions for the seller.

### SUMMARY OF THE INVENTION

The preferred embodiments of the present invention provides a system and method for enabling an auction or fixed-price seller, referred to herein as the “seller,” to display the seller's international shipping experience over a geographic map display on the market venue selling page of the seller. This displayed shipping experience map acts as a signal of trust to international buyers considering a purchase from the displaying seller on any market venue. Although international sales are discussed below, it will be appreciated that the invention could be used for sales within a country.

After establishing the seller's account, including the establishment of existing international shipping transactions by self-verification or through the uploading of completed transaction records, the system creates a shipping experience map image and provides the seller with HTML text to display the seller's international shipping experience map image on the seller's item selling page. In the preferred embodiment, this HTML text is provided via email. Subsequently, the system automatically receives transaction information for the seller from the seller's market venue or ecommerce web site. Received transactions are evaluated by a software program to determine if the buyer in the transaction is an international buyer. When an international buyer transaction is identified, the system increments a cumulative count of shipments to the buyer's geography and updates the display of the shipping experience map to represent the added information.

This system and method is comprised of an international shipping experience map registration by the seller. Seller registration occurs by providing the seller with access to a registration software program on a web server where the seller can initiate their international shipping experience map. The registration software updates a seller database which includes, but is not limited to, seller information including seller name, seller's market user ID, address, active/inactive status, billing information, as well the market venue the seller sells through and/or the web address of the seller's own store web site. In addition, each seller record in the seller database includes an updated count of cumulative shipments made to various geographies covered by one or more maps selected by the seller during registration. In the preferred embodiment, geographies can be continents, countries, states, provinces, regions, metropolitan areas, cites or towns.

The seller initiates the international shipping experience map system by updating and completing HTML forms within the international shipping experience map web site. Since the seller will most likely have made shipments to buyers prior to registration, during seller registration the seller may optionally enter a self-certified or self-verified count of existing international shipments for the areas covered by the maps selected by the seller. The self-certified count of international shipments by geographic area becomes the starting point for the count of existing international shipments to the associated areas in the seller record for display on the international shipping map image selected by the seller.

Additionally, during registration the seller is given the option of uploading a file of existing prior transactions including the international shipping destination of the prior transactions to initiate the seller's shipping experience database. The registration software can receive this optional file and place the uploaded international shipping destination file into the seller's database in the appropriate geographic fields. The sum total of multiple instances of shipments to the same geographic location from prior transactions becomes the seller's starting point for the cumulative count of existing international shipments to the geographic area chosen by the seller.

The seller also provides for the system to receive transaction information from the seller's preferred market venue or the system may poll the market venue for transaction information for the seller. In this way, all the seller's future international shipments can be captured and added to the database for subsequent representation on the international shipping experience map or maps.

Once the seller completes registration, his/her repeat international shipping map display image is established by overlaying a count or a symbol of experience onto the geographic area(s) of the map where the seller has shipped. The count is a cumulative count of shipments. The symbol may be the image of a stick-pin, shading of the area or other such designation of experience in shipping to that geography which is overlain on the map.

To display the international shipping experience map, the seller is given access to HTML text for inclusion on a web page or within an email. In a preferred embodiment, the access is given via an email sent to the buyer. Said email contains the HTML text.

The HTML text, when placed onto a web page or within a HTML enabled email, calls the seller's international shipping experience map image to the target location. The seller can place the provided HTML text on the market venue's listing web page or on the seller's own e-commerce web site or within outbound HTML enabled emails. Subsequently, when the buyer opens their browser on the market venue seller's item listing page, or opens the browser on to the seller's e-commerce listing page or the buyer opens an email with an HTML enabled email reader, the HTML code initiates a call to the system and the updated image of the seller's international shipping experience map is presented within the web-pages or email. In a preferred embodiment, additional information relating to the seller's shipping map can be viewed by clicking on the shipping map.

During registration, the system provides for the seller to make subsequent transaction information available to the system. After registration, the system continually receives seller transaction information from the market venue or from the seller's e-commerce web site. Each transaction record is analyzed and stored in a seller transaction database. At a minimum, the transaction information includes the destination of the shipment. A software program evaluates if the shipment destination for the received transaction matches an existing destination covered by the map or maps in the seller's database record. If so, the system increments the cumulative international shipping count for that geographic location in the seller's database record. If not, the location is recorded in the database as a non-covered shipment.

Whenever the image hosting server receives a call from the HTML code, it presents the most updated international shipping experience map image to the appropriate calling web-page or email reader so that the buyer sees the most recent expression of the international shipping experience map for that seller.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a international shipping experience map system for displaying a shipment experience as an overlay on a geographic map image on a web-page or in an email.

FIG. 2 is a block flow diagram illustrating the method in accordance with the invention.

FIG. 3 is a diagram of information for a seller account record for use with one embodiment of the present invention

FIGS. 4A-4C are screen displays of the seller registration on-line form which is completed by the seller to create a seller database record.

FIG. 5 is a sample international shipping experience map image display.

FIG. 6 is a sample screen display of a market venue listing page with the international shipping experience map displayed.

FIG. 7 is a sample buyer HTML-enabled email with the international shipping experience map displayed.

FIG. 8 is a sample screen display of a subsequent detailed map showing the count of shipments and a seller's item gallery.

### DETAILED DESCRIPTION

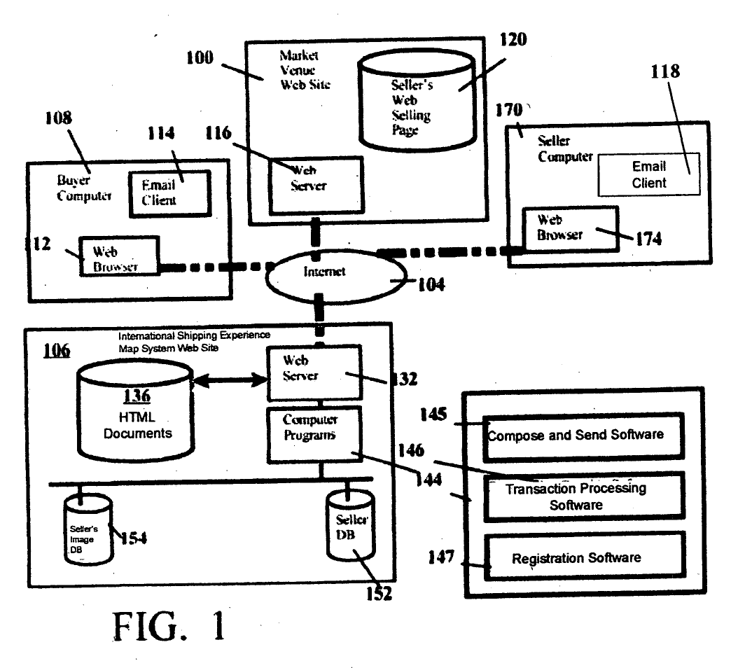

FIG. 1 is a high-level architectural drawing illustrating the primary components of an international shipping experience map system for graphically presenting the experience a seller has in shipping to a geographic location and to display the experience on a map shown on the seller's item selling web-pages or within outbound emails. The international shipping experience map system includes a buyer computer 108, a market venue web site 100, a seller computer 170 and an international shipping experience map system web site 106, all of which are linked together by the Internet 104.

The buyer computer 108 may be any type of computing device that allows the buyer to receive and respond to emails 114 and interactively browse Web sites via a Web browser 112. For example, the buyer computer 108 may be a personal computer (PC) that runs the Windows NT operating system and Netscape Navigator and which can access the Yahoo Mail email service at Yahoo.com.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The market venue web site 100 is a web site such as eBay.com, Overstock.com, Amazon.com or Yahoo.com, which provides various functionality for allowing sellers to post listings for sale and for buyers to make offers to purchase said listings via highest bid or a fixed price buying method over the Internet using their Web browser. Typically, the market venue web site 100 will be operated by a business entity that handles marketing functions to attract both buyer and seller to its site. The market venue web site 100 handles technical tasks to facilitate posting listings for sale, subsequent transaction processing including bid recording and final winning bid determination, reporting associated with the sale of almost anything between a buyer and seller and the presentation of a seller's web selling page 120 to a buyer. The market venue web site uses a web server 116 to send information as HTML web page displays, HTTP files, and emails to various entities, including the buyer computer 108, the seller computer 170, and the international shipping experience map system 106, over the internet 104 as is required to conduct appropriate transactions with each party. In one embodiment of the invention, the Market Venue Web Site 100 can also be an e-commerce web-site where a seller sells their own items.

The international shipping experience map system web site 106 advantageously includes a web server 132 and HTML documents 136, a seller account database 152 and a seller map image database 154 and multiple computer software programs 144

The seller computer 170 may be any type of computing device that allows the seller to interactively browse Web sites via a Web browser 174 and allows the seller to receive and respond to emails 118. For example, the seller computer 170 may be a personal computer (PC) that runs the Windows 2000 operating system running Internet Explorer and accesses email through Microsoft Outlook.

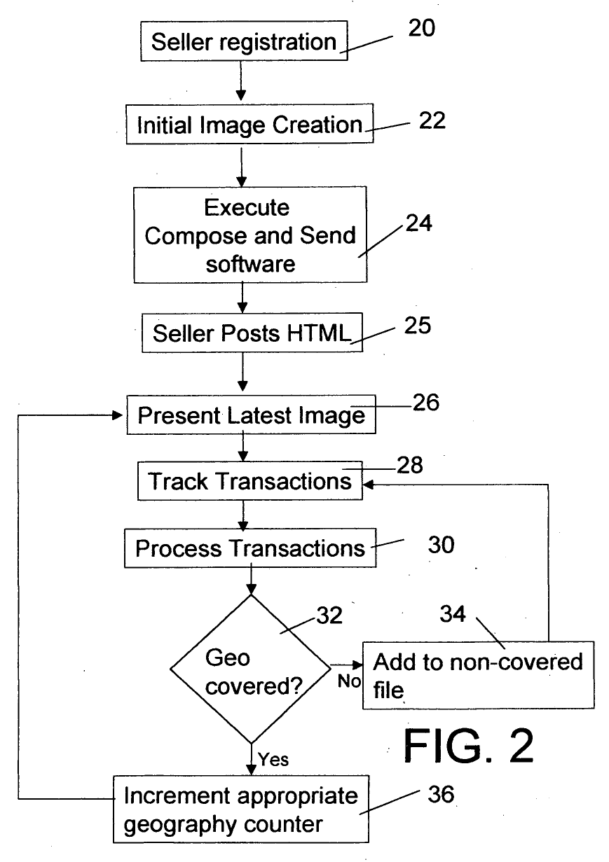

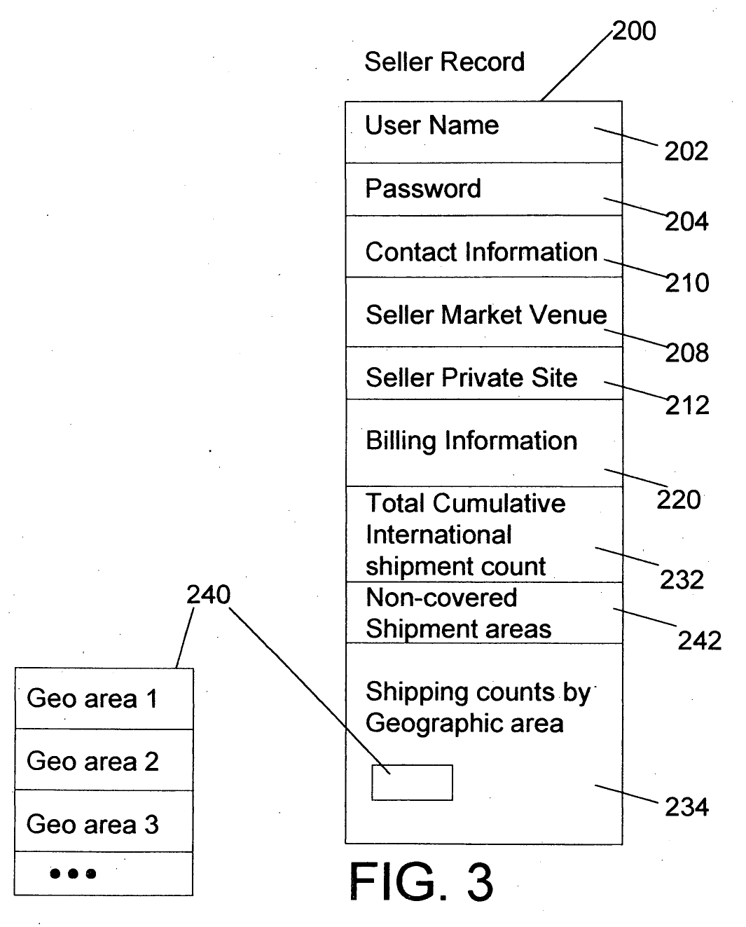

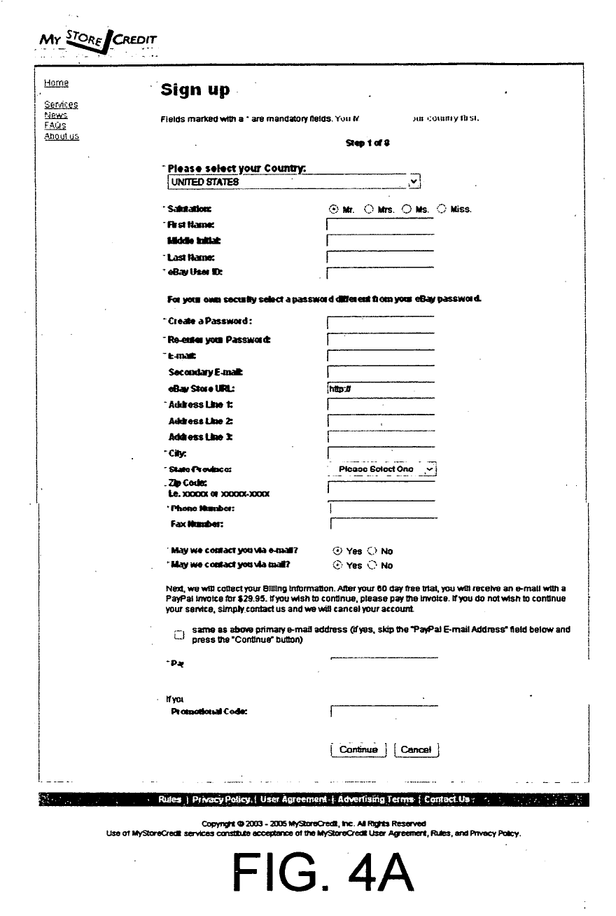

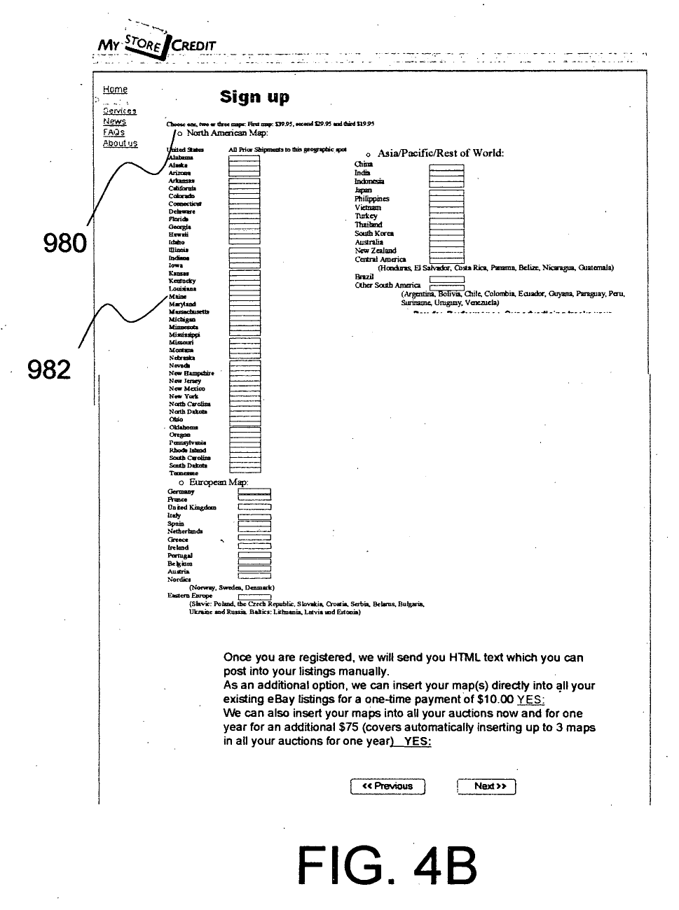

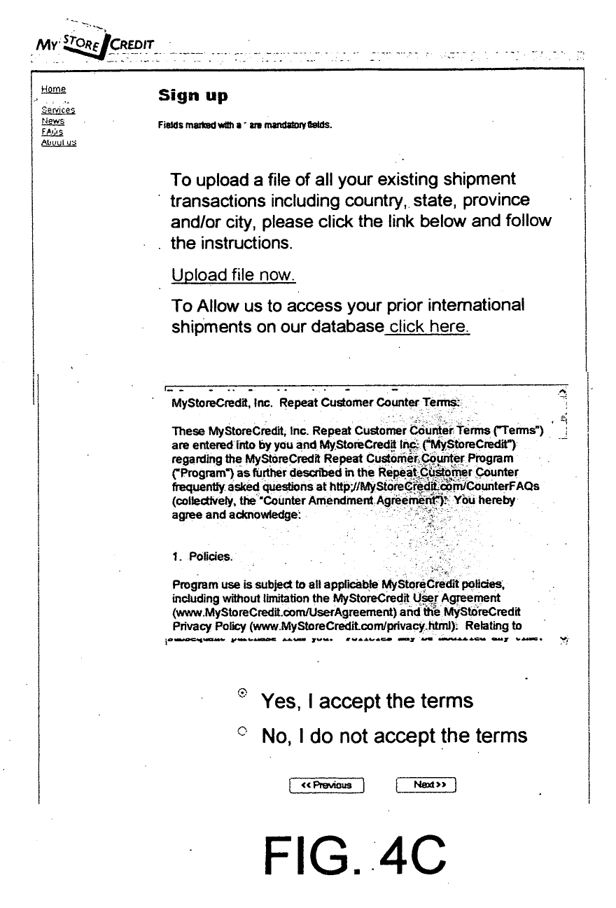

FIG. 2 is a general flow diagram of the method of this invention. Referring to this figure, the invention provides sellers with a mechanism to register for the international shipping experience map system. This activity is reflected as step 20 as detailed in the general flow diagram in FIG. 2. One embodiment of the sell registration image 136 is illustrated in FIGS. 4A-4C. In the preferred embodiment of the invention, sellers are presented with both the opportunity to enter a self-verified existing count of prior shipments made to various geographic locations within each map selected, FIG. 4B. Alternatively, sellers are given the option to authorize the system to access a file of shipment locations from the seller's prior transactions, FIG. 4C. The alternative authorization comes in the form of permission to access the seller's prior transactions if available or is expressly granted by the seller uploading a file of prior shipments to the system. The registration software 147, FIG. 1, accepts the uploaded file or accesses the seller's history files. In all cases, the system counts the total shipments made by geographic location associated with the seller's history and places the sum of the shipments into the seller's total cumulative international shipments field 232, FIG. 3, of the seller's record. The cumulative count for each shipments to individual geographic areas are placed in the shipment count by geography set 240, FIG. 3, of the seller's record housed in the seller account database 152. In this way, the system establishes a total prior international shipment count and a prior shipment count for each geographic area as the base to which future shipments will be added.

Upon registration completion, the system creates the initial components of the seller's shipping experience map in a record within the system's seller image database 154 (Step 22). To create the seller's unique image, the system first identifies a blank target geographic map image associated with area the seller identified during registration. In the preferred embodiment, blank target geographic maps represent a geographic area such as North America, Europe, Asia/Rest of the World. Specific smaller geographic areas within each targeted map will have a corresponding entry in the shipment count by geography area set 240, FIG. 3, which also includes the seller's prior history count. Each geography set 240 also is associated with a specific pixel location on the targeted blank map holding that geographic location.

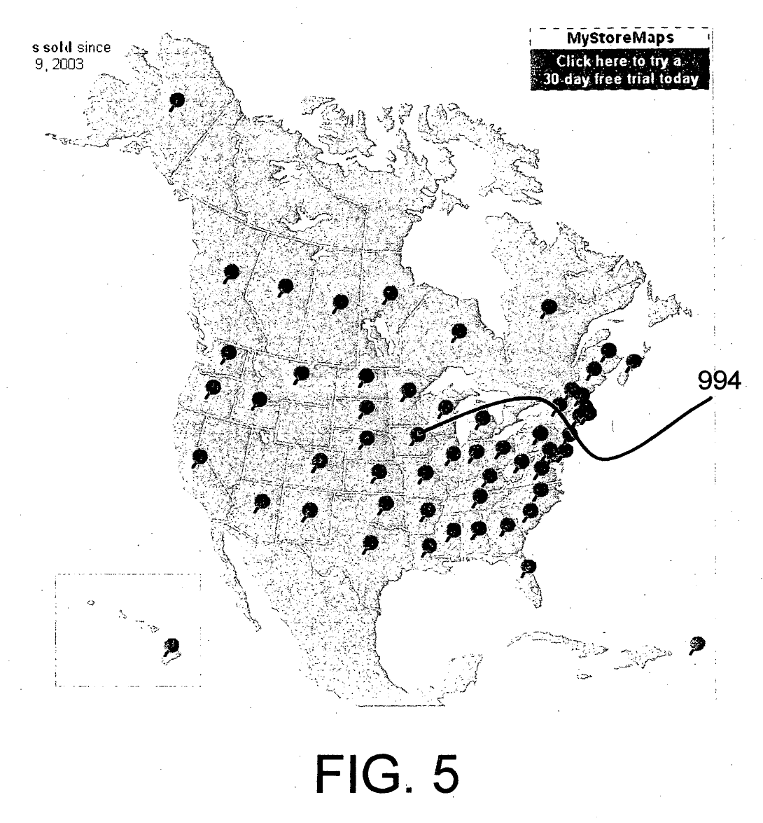

For example, if during registration a seller chose a map of North America (980, FIG. 4B), the system would call a blank targeted map of North America and then scan through the various shipment counts entered by geography area recorded in the North American map including all 50 states and other areas of North America (982, FIG. 4B). After registration, each geography area would hold a the count entered by the seller or a zero associated with each location. At step 22, initial image creation, the existing entry in the geography set 240, FIG. 3, will be placed on the corresponding location for each geography on the blank map. For example, in a map of North America, approximate location on the blank target map for Nebraska would be the center pixel of the blank targeted North American map. The center pixel (994, FIG. 5) might be identified in the appropriate geography set 240, FIG. 3, for the geography location as coordinate of an image pixel such as 345, 345 where the two numbers represents the intersection of the width and length coordinates of the image. In this example, the pixel coordinate is the location the system will overlay the existing count of shipments the seller has made to Nebraskan buyers as found in the Nebraska geography field 240, FIG. 3. The system can overlay a symbol of shipping experience on that pixel location. Such symbol can be an image of a stick-pin, a numeric count, a dot or other such symbol. The system would place the count or symbol over the map pixel location for every appropriate geographic area within the selected map, and would m geographies with no shipments as zero or leave blank. After the counts are overlaid on the appropriate corresponding pixel location, the final map is created and stored in the seller's image database 154, FIG. 1.

Additional embodiments of the map are expected. Each geographic map is labeled and each geographic area in a map can be a street, city, country, state, province or other geographic region within the identified map. For instance, a map of Europe might list specific countries, but could also consist of super-regions such as the Baltics or the Nordics or might include cities like Paris, London and Rome. As another example, a map may exist for one state, such as North Carolina, and within the state, cities or towns can be represented. Buyers could click on each map to zoom in to the appropriate detail level map for their interests.

At step 24, the system executes the compose and send email software program 145, FIG. 1, to send the seller an email containing unique HTML text capable of calling the international shipping experience map image for the appropriate seller to a web page or HTML enabled email. The email created by the compose and send email software 145 includes combining the seller's email address from the seller's contact information 210, FIG. 3, along with pre-defined HTML text from the HTML docs 136 and sending the email via the internet 104 to be read by the seller using the seller's email client 118.

At step 25, the seller opens the email and copies and pastes the HTML text into the appropriate place on the seller's web selling page 120 or into the appropriate place to be shown within the buyer's email client 114. Alternatively, the system can place the image into the seller's listings directly on their own ecommerce site.

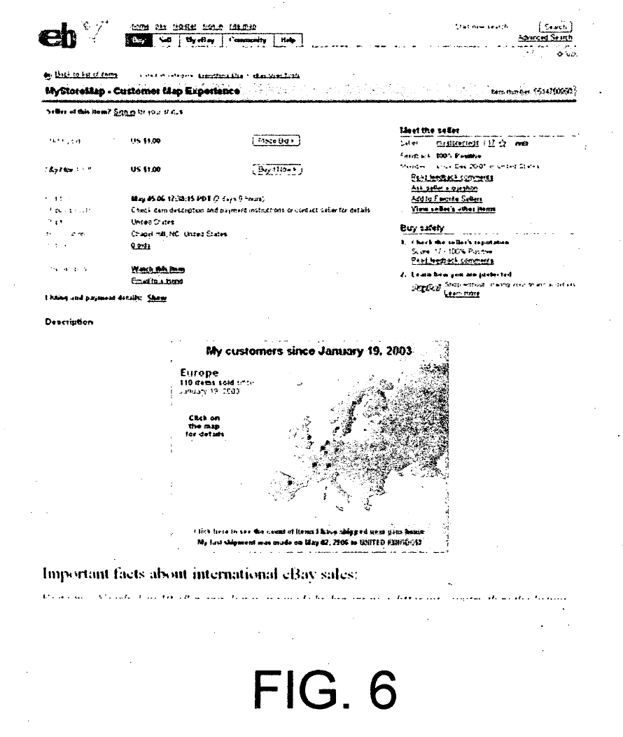

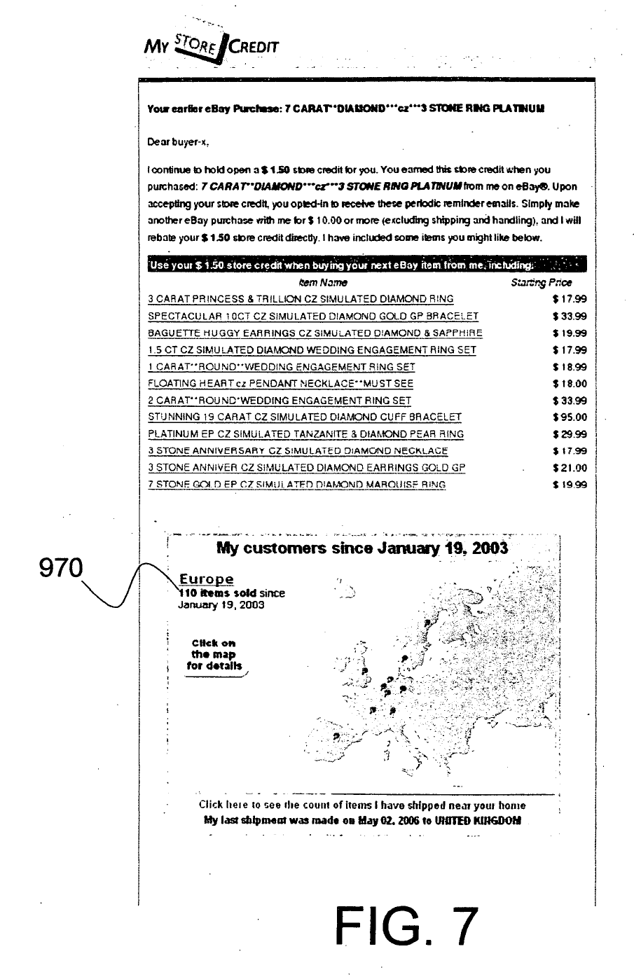

Subsequently, in Step 26, whenever a buyer uses his/her web browser 112 to open a seller's web selling page 120 which includes the HTML text (FIG. 6) or whenever a buyer opens an HTML enabled email message which includes the HTML text (FIG. 7) by using his/her email client 114, the system responds to the HTML text's call and the seller's latest international shipping experience map image is presented from within the seller's image database 154, FIG. 1, with the current geographies updated where the seller has shipped with a cumulative count or symbol as represented by the international selling experience map in the seller's image database 15 combined with appropriate HTML docs 136 and presented as the image through the web server 132 over the internet 104 to the correct calling location to display the international shipping experience map. Alternatively, the image can be created real-time upon receiving the HTML text's call and the map image can be created using all available information and then can also be sent.

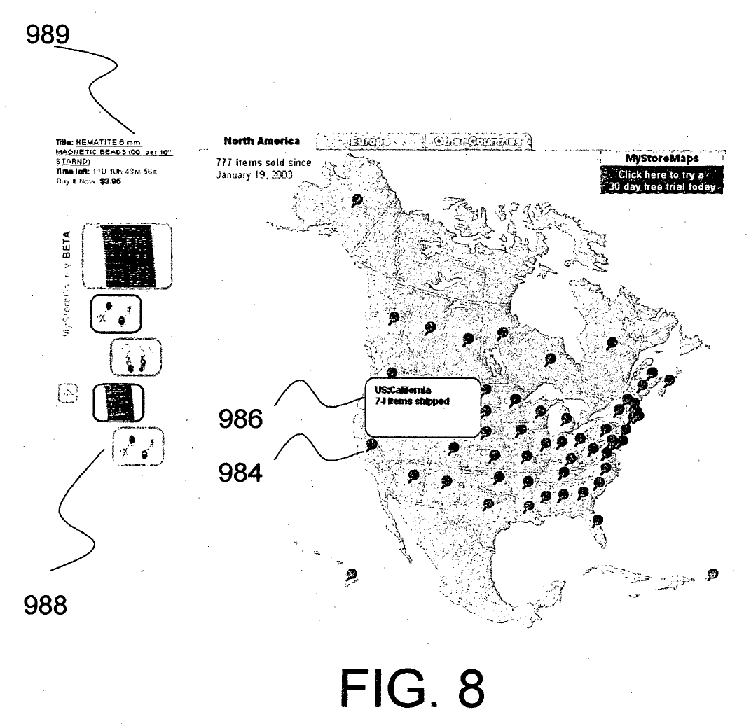

In one embodiment of the invention, the buyer can be instructed to click on the displayed map to view additional details about the map. Upon clicking on the displayed map in the email (FIG. 7) or the web listing page (FIG. 6) a widow window is opened in the buyer's web browser (112, FIG. 1). A sample of the widow window is shown in FIG. 8. Referring to this figure, the detailed map can show more details about the geography covered in the map. For instance, a buyer may click on the symbol for California (984) and an informational box (986) can relay the geography clicked and relevant shipping information to that geography, such as the count of shipments made to the geography. In addition, as show in FIG. 8, the detail map can show a buyer a gallery of other items the seller is selling (988). This gallery adds cross-selling functionality to the displayed detail map so the buyer is shown the seller's additional items to consider for purchase. Each item in the gallery can be highlighted and relevant information about the item for sale can be shown to the buyer viewing the detail map (989).

The system subsequently tracks a seller's international shipments by capturing seller transactions from the Market venue web site 100, Step 28. In one embodiment of the invention, at the close of every market venue transaction for a registered seller, the Market Venue web site 100 sends an electronic message over the internet 104 to the international shipping experience map system web site server 132, where the system processes the received transaction using the transaction processing software 146. In another embodiment, the transaction processing software 146 polls the market venue web server 116 over the internet 104 for any closed seller transactions. In another embodiment, the seller can cause closed transaction information to be sent to the International shipping experience map system web site server 132 in the form of a daily upload of transactions, an RSS feed of transactions or other methods.

At Step 30, each transaction is processed by the transaction processing software 146. In the preferred embodiment, the minimum transaction data captured is the buyer's shipment address for the transaction. Alternatively, other transaction data, including purchase price, date and time of transaction, email address of the buyer, etc. are parsed and placed into appropriate corresponding fields in the seller account database 152.

At step 32, the transaction processing software 146 evaluates if the shipment address from the received transaction matches existing geographic area covered by the seller's map as identified in the shipment count by geographic area fields 234 in the seller's record in the sellers account database 152. If no, Step 34, the shipment address is added into non-covered shipment ID field 242 in the seller's record in the seller account database 152 and the system returns to step 28 to track further transactions. If, in Step 32, a match is determined, the system moves to Step 36 and the seller's cumulative shipment count for the appropriate geography record 240 in the seller account database 152 is incremented by one.

Next, the system returns to Step 26 to provide the latest international shipping experience map image FIG. 5 for the next HTML call stimulated by a viewing buyer.

FIG. 3 is a diagram showing the types of information contained in a seller account record 200 in the seller account database 152. Each seller record 200 contains a user name 202 and a password 204, used to access the seller's account record. The account record also contains contact information 210, the seller's market venue ID 208 and the seller's private selling site web-address 212. The account record 200 also contains billing information 220.

The total cumulative international shipment count 232, represents the total packages shipped by the seller. This number can be displayed on the seller's shipping map, 970, FIG. 7. The non-covered shipment areas, 242, represent the geographies identified in step 34, FIG. 2. The shipment count by geographic area set 234 for each seller account 200 is made up of a set of unique geographic areas set 240 for each geographic area covered by the map or maps selected by the seller during registration. For instance, individual states, provinces, cities and countries can be included as separate records in the geographic area set 240. Each individual record will include the name of the geographic area, the count of shipments to that area, the map associated with that area and the pixel location for the map where the current shipment count or symbol associated with the geographic area should be placed.

It will be appreciated by those skilled in the art that numerous modifications and variations are possible, and that the invention may be practiced otherwise than as specifically described herein, without departing from the scope thereof.

What is claimed is:

1. A shipping experience map display system, comprising:
a shipment database storing at least one count of shipments by a seller to at least one destination,
a map database storing at least one shipping experience map image;
a server computer connected to a wide area network; and
software program code comprising computer executable code stored in a storage medium, said software program code further comprising:
software program code for receiving notification of at least one transaction between said seller and said at least one buyer;
software program code subsequently determining if said transaction includes a shipment made to said at least one destination, and
software program code incrementing said count of shipments to said at least one destination accordingly; wherein:
said at least one shipping experience map display image is presented over said wide area network by said server computer, and
said at least one shipping experience map display image including characters representing the shipping experience a seller has for the geographic area represented within said shipping experience map display;

2. The shipping experience map system according to claim 1, wherein said shipment database comprises:
characters representing a shipping experience;
pixel coordinates for placement of said characters; and
a map association indicator for said geographic area.

3. The shipping experience map system according to claim 1, said software program code further comprising:
software program code for said seller registration, and
software program code for composing and sending email to said seller.

4. The shipping experience map system according to claim 1, wherein:
said notification of said at least one transaction is received from a market venue attached to said wide area network.

5. The shipping experience map system according to claim 1, wherein:
said notification of said at least one transaction is received from an ecommerce web site attached to said wide area network.

6. The shipping experience map system according to claim 1, wherein:
said shipping experience map image is presented in an email.

7. The shipping experience map system according to claim 1, wherein:
said shipping experience map image is presented on an item listing page of said seller at said market venue.

8. The shipping experience map system according to claim 1, wherein:
said wide area network is the Internet.

9. A method for enabling a server to display an updated image of an shipping experience map for a seller at a market venue, comprising the steps of:
registering said seller,
determining initial values of each of a plurality of cumulative counts of shipments to each of a plurality of geographic areas,
providing said seller with code to call an image of said international shipping experience map;
receiving a record of a subsequent transaction for said seller;
determining if a shipment destination of said subsequent transaction is covered by said shipping experience map;
incrementing one of said cumulative counts of shipments to one of said plurality of geographic areas accordingly; and
posting said updated international shipping experience map image when called.

10. The method according to claim 9, wherein:
said step of determining initial values of each of a plurality of cumulative counts of shipments to each of a plurality of geographic areas comprises submitting self-verified information from said seller.

11. The method according to claim 9, wherein:
said step of determining initial values of each of a plurality of cumulative counts of shipments to each of a plurality of geographic areas comprises evaluating shipment destinations from prior transactions.

12. The method according to claim 9, further comprising the step of:
placing said code on a seller's web page at said market venue.

13. The method according to claim 9, further comprising the step of:
placing said code in an email to a prospective buyer.

14. The method according to claim 9, wherein:
said code is in Hypertext Markup Language (HTML).

15. A system for enabling a server to display an updated image of an shipping experience map for a seller at a market venue, comprising:
means for registering said seller,
means for determining initial values of each of a plurality of cumulative counts of shipments to each of a plurality of geographic areas,
means for providing said seller with code to call an image of said international shipping experience map;
means for receiving a record of a subsequent transaction for said seller;
means for determining if a shipment destination of said subsequent transaction is covered by said shipping experience map;
means for incrementing one of said cumulative counts of shipments to one of said plurality of geographic areas accordingly; and
means for posting said updated international shipping experience map image when called.

16. The system according to claim 15, wherein:
said means for determining initial values of each of a plurality of cumulative counts of shipments to each of a plurality of geographic areas comprises means for submitting self-verified information from said seller.

17. The system according to claim 15, wherein:
said means for determining initial values of each of a plurality of cumulative counts of shipments to each of a plurality of geographic areas comprises means for evaluating shipment destinations from prior transactions.

18. The system according to claim 15, further comprising the step of:
means for placing said code on a seller's web page at said market venue.

19. The system according to claim 15, further comprising the step of:
means for placing said code in an email to a prospective buyer.

20. The system according to claim 15, wherein:
said code is Hypertext Markup Language (HTML).
